(19) United States
(12) Patent Application Publication
(10) Pub. No.: US 2020/0092893 A1
(43) Pub. Date: Mar. 19, 2020

(54) DISTANCE MEASUREMENTS BASED ON ROUND-TRIP PHASE MEASUREMENTS

(71) Applicant: QUALCOMM Incorporated, San Diego, CA (US)

(72) Inventors: Thomas ALLAN, St Neots (GB); Paul Dominic HISCOCK, Cambridge (GB)

(21) Appl. No.: 16/133,478

(22) Filed: Sep. 17, 2018

(51) Int. Cl. H04W 72/08; H04W 72/04

(52) U.S. Cl. CPC H04W 72/085; H04W 72/0453

(57) ABSTRACT

The present disclosure provides a frequency hopping technique that may remove the effects of radial motion while making phase measurements (e.g., RTP measurements) by taking symmetric samples/RTP measurements of a signal transmitted and received for a set of carrier frequencies around the center time of an RTP measurement campaign.

### BACKGROUND

### Field

The present disclosure relates generally to communication systems, and more particularly, to determining a distance between two devices based at least in part on round-trip phase (RTP) measurements.

### Background

A wireless personal area network (WPAN) is a personal, short-range wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, a Bluetooth® Low Energy (BLE) protocol, a Zigbee° protocol, etc.), provide wireless connectivity to peripheral devices by providing wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs.

To address the power consumption issue associated with BT, BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may be established using, e.g., hardware, firmware, host operating system, host software stacks, and/or host application support. Example applications that use BLE include battery-operated sensors and actuators in various medical, industrial, consumer, and fitness applications. BLE may be used to connect devices such as BLE enabled smart phones, tablets, and laptops.

Satellite positioning systems (SPSs), such as the global positioning system (GPS), have enabled navigation services for mobile handsets in outdoor environments. Likewise, particular techniques for obtaining estimates of positions of BT and/or BLE devices in indoor environments may enable enhanced location based services in particular indoor venues such as residential, governmental or commercial venues. For example, a distance between a mobile device and a transceiver positioned at fixed location may be measured based, at least in part, on a measurement of a received signal strength (RSSI) or a round trip time (RTT) measured between transmission of a first message from a first device to a second device and receipt of a second message at the first device transmitted in response to the first message. There exists a need for further improvements determining a distance between two BT and/or BLE devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Use of RTT and RSSI measurements for determining a distance between devices using RTT and/or RSSI measurements may lead to inaccuracies in distance estimation in band limited systems such as BT. The inaccuracies may occur in part because accuracy typically depends on determination of precise times of reception and departure in the presence of drifting clocks and complex receive chains. Accordingly, measuring a distance between devices using RTT and/or RSSI based measurements may be complex and may suffer inaccuracies in the presence of clock drift and multipath.

To avoid the inaccuracies described above with RTT and/or RSSI measurement, the distance between a first and second device may be measured based, at least in part, on multiple round trip-phase (RTP) measurements obtained using wireless tone signals transmitted between the first device and a second device.

However, when using RTP measurements with tone signals transmitted at substantially the same carrier frequency, an assumption is made that the first device and the second device are stationary, which may not always be the case. In practice, the phase measurements (e.g. RTP measurement of the different carrier frequencies) may be made sequentially over a period of time and if either the first device or the second device is moving, the phase measurements may be made in different positions, which may corrupt the final distance estimation. In certain implementations, RTP may be used as a security measure to determine a proximity to a device, such as a laptop or car, and making an error in distance measurement may lead to security risks. Thus, there exists a need for accurately determining the distance between two devices using RTP measurements when at least one of the devices is moving.

The present disclosure provides a solution using a frequency hopping technique that may remove the effects of radial motion while making phase measurements (e.g., RTP measurements) by taking symmetric samples/RTP measurements of a set of carrier frequencies around the center time of a duration of all RTP measurements.

It should be understood that the aforementioned implementations are merely example implementations, and that claimed subject matter is not necessarily limited to any particular aspect of these example implementations.

In an aspect of the disclosure, a method, a computer-readable medium, and an apparatus are provided. The apparatus may transmit a first set of signals in a first order to a second wireless device. In certain aspects, each signal in the first set of signals may be associated with a different carrier frequency of a set of carrier frequencies. The apparatus may receive a second set of signals in the first order from the second wireless device. In certain aspects, each signal in the second set of signals may be associated with a carrier frequency in the set of carrier frequencies. In certain other aspects. In certain other aspects, each signal in the second set of signals may be received in the first order in response to a signal in the first set of signals being transmitted to the second wireless device using a same carrier frequency prior to an RTP measurement center time. In certain other aspects, the RTP measurement center time may be a center time of an RTP measurement campaign. The apparatus may transmit a third set of signals in a second order to the second wireless device. In certain aspects, the second order may be a reverse of the first order. In certain other aspects, the first order and the second order may be symmetrical around the RTP measurement center time. In certain other aspects, each signal in the third set of signals may be associated with a carrier frequency in the set of carrier frequencies. The apparatus may receive a fourth set of signals in the second order from the second wireless device. In certain aspects, each signal in the fourth set of signals may be received in the second order in response to a signal in the third set of signals being transmitted to the second wireless device using a same carrier frequency after the RTP measurement center time. In certain other aspects, each signal in the fourth set of signals may be associated with a carrier frequency in the set of carrier frequencies.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN in accordance with certain aspects of the disclosure.

FIG. 2 is block diagram of a wireless device in accordance with certain aspects of the disclosure.

FIG. 3 is a diagram illustrating a modified BLE protocol stack in accordance with certain aspects of the disclosure.

FIGS. 4A and 4B illustrate frequency verses phase plots of RTP measurements obtained using a random hopping sequence in order to simulate the effect of sampling order when determining a distance between two devices when one of the devices is moving in accordance with certain aspects of the disclosure.

FIG. 5 illustrates a frequency verses phase plot of RTP measurements obtained using a Bluetooth hopping sequence in order to simulate the effect of sampling order when determining a distance between two devices when one of the devices is moving in accordance with certain aspects of the disclosure.

FIG. 6 illustrates a set of carrier frequencies that may be symmetrically sampled around a center time of an RTP measurement to remove the effect of phase accumulated from a radial velocity in determining a distance measurement in accordance with certain aspects of the disclosure.

FIG. 7 illustrates a set of carrier frequencies that may be symmetrically sampled around a center time of an RTP measurement to remove the effect of phase accumulated from a radial velocity in determining a distance measurement in accordance with certain aspects of the disclosure.

FIG. 8 illustrates a set of carrier frequencies that may be symmetrically sampled around the center time of an RTP measurement to remove the effect of phase accumulated from a radial velocity in determining a distance measurement in accordance with certain aspects of the disclosure.

FIG. 9A illustrates a set of carrier frequencies that may be symmetrically sampled around the center time of an RTP measurement to remove the effect of phase accumulated from a radial velocity while determining a distance measurement in accordance with certain aspects of the disclosure.

FIG. 9B illustrates a set of carrier frequencies that may be symmetrically sampled around a center time of an RTP measurement to remove the effect of phase accumulated from a radial velocity in determining a distance measurement in accordance with certain aspects of the disclosure.

FIG. 10 illustrates a graphical plot of absolute errors that are accumulated in a distance measurement between two devices while one device is in motion using a monotonic sweep, a first Bluetooth hopping sequence, a second hopping sequence, and symmetric frequency sequence of the present disclosure.

FIG. 11 is a flowchart of a method of wireless communication.

FIG. 12 is a conceptual data flow diagram illustrating the data flow between different means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

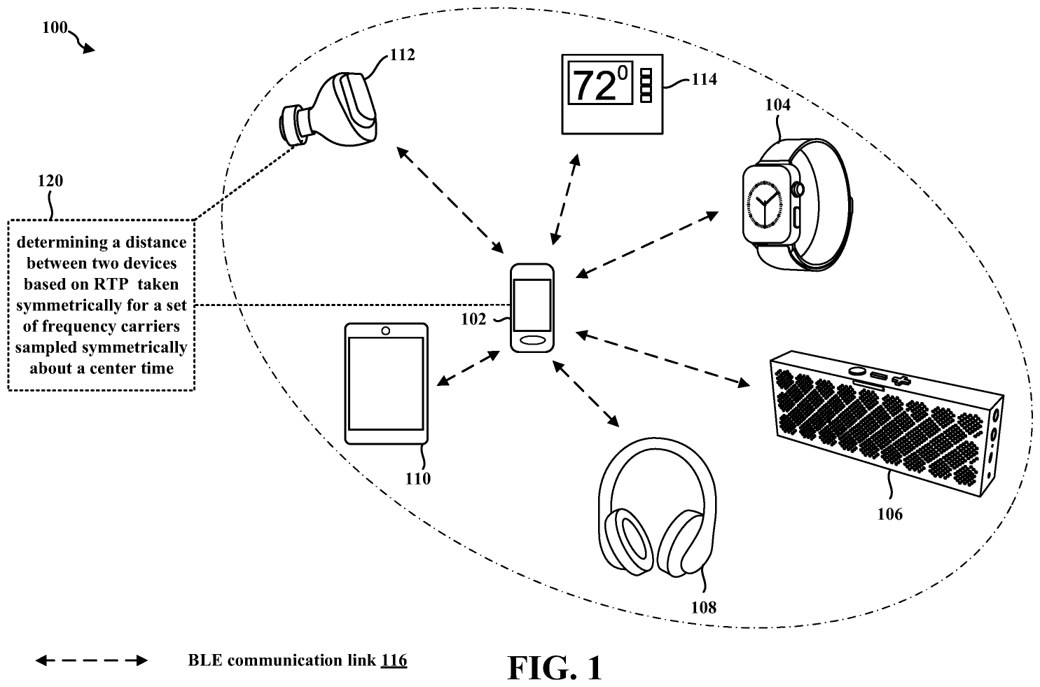

FIG. 1 illustrates an example WPAN 100 in accordance with certain aspects of the disclosure. Within the WPAN 100, a central device 102 may connect to and establish a BLE communication link 116 with one or more peripheral devices 104, 106, 108, 110, 112, 114 using a BLE protocol or a modified BLE protocol. The BLE protocol is part of the BT core specification and enables radio frequency communication operating within the globally accepted 2.4 GHz Industrial, Scientific & Medical (ISM) band.

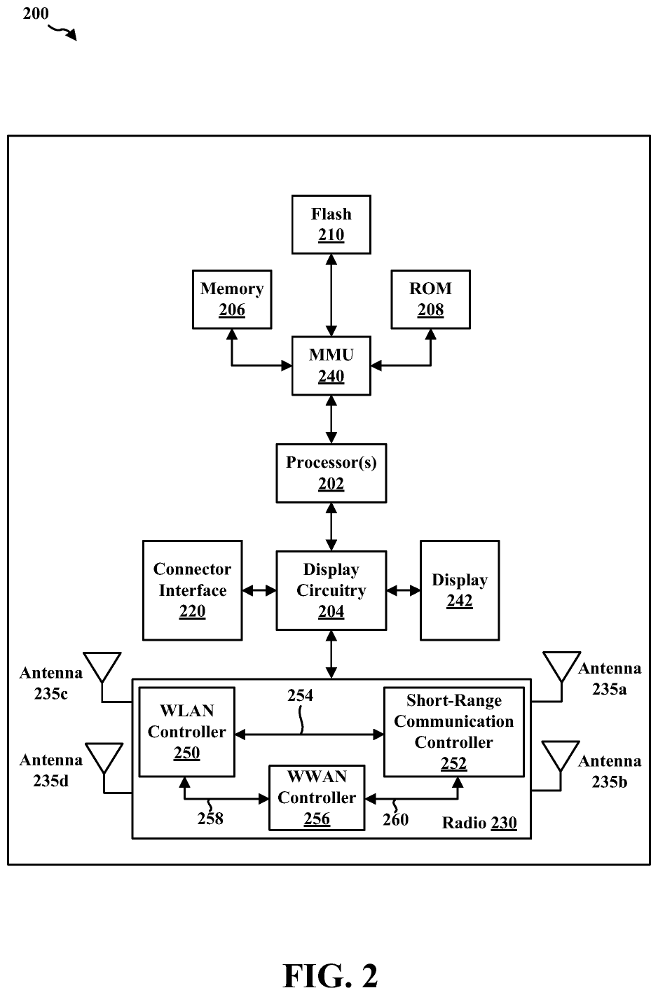

The central device 102 may include suitable logic, circuitry, interfaces, processors, and/or code that may be used to communicate with one or more peripheral devices 104, 106, 108, 110, 112, 114 using the BLE protocol or the modified BLE protocol as described below in connection with any of FIGS. 2-13. The central device 102 may operate as an initiator to request establishment of a link layer (LL) connection with an intended peripheral device 104, 106, 108, 110, 112, 114.

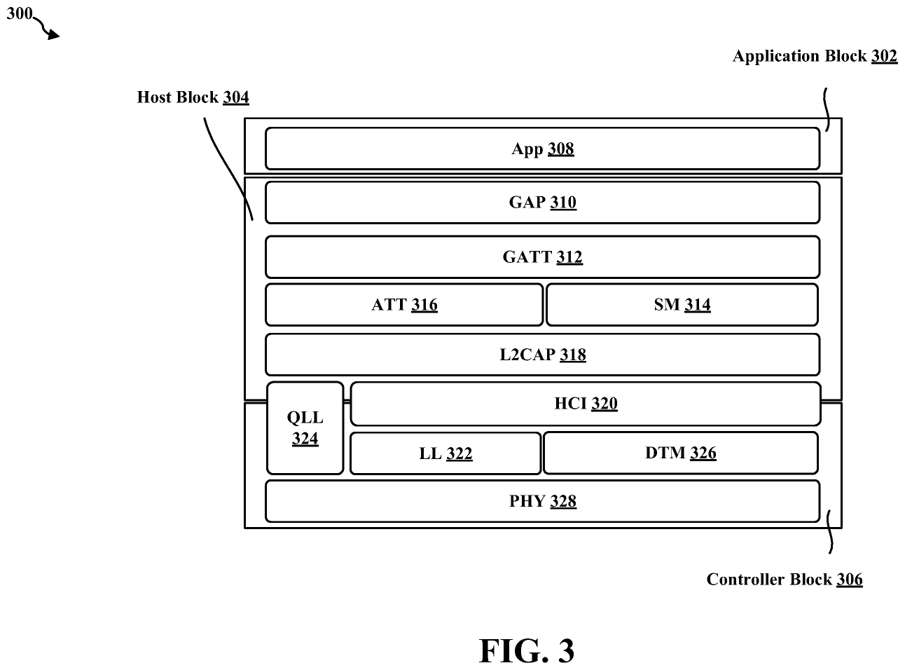

A LL in the BLE protocol stack and/or modified BLE protocol stack (e.g., see FIG. 3) provides, as compared to BT, ultra-low power idle mode operation, simple device discovery and reliable point-to-multipoint data transfer with advanced power-save and encryption functionalities. After a requested LL connection is established, the central device 102 may become a master device and the intended peripheral device 104, 106, 108, 110, 112, 114 may become a slave device for the established LL connection. As a master device, the central device 102 may be capable of supporting multiple LL connections at a time with various peripheral devices 104, 106, 108, 110, 112, 114 (slave devices). The central device 102 (master device) may be operable to manage various aspects of data packet communication in a LL connection with an associated peripheral device 104, 106, 108, 110, 112, 114 (slave device). For example, the central device 102 may be operable to determine an operation schedule in the LL connection with a peripheral device 104, 106, 108, 110, 112, 114. The central device 102 may be operable to initiate a LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, 114 may take place within connection events.

In certain configurations, the central device 102 may be configured to transmit the first LL data PDU in each connection event to an intended peripheral device 104, 106, 108, 110, 112, 114. In certain other configurations, the central device 102 may utilize a polling scheme to poll the intended peripheral device 104, 106, 108, 110, 112, 114 for a LL data PDU transmission during a connection event. The intended peripheral device 104, 106, 108, 110, 112, 114 may transmit a LL data PDU upon receipt of packet LL data PDU from the central device 102. In certain other configurations, a peripheral device 104, 106, 108, 110, 112, 114 may transmit a LL data PDU to the central device 102 without first receiving a LL data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, 114 may include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, 114 in the WPAN 100, the central device 102 may communicate with more or fewer than six peripheral devices within the WPAN 100 without departing from the scope of the present disclosure.

Referring again to FIG. 1, in certain aspects, the central device 102 and/or one of the peripheral devices 104, 106, 108, 110, 112, 114 may be configured to determine a distance between two devices based on RTP measurements for a set of carrier frequencies sampled symmetrically about a center time (120), e.g., as described below in connection with any of FIGS. 2-13.

FIG. 2 is block diagram of a wireless device 200 in accordance with certain aspects of the disclosure. The wireless device 200 may correspond to, e.g., the central device 102, and/or one of peripheral devices 104, 106, 108, 110, 112, 114 described above in connection with FIG. 1. In certain aspects, the wireless device 200 may be a BLE enabled device.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., wireless devices in a WPAN.

In certain aspects, the wireless device 200 may include hardware and software components (a processing element) configured to determine a distance between two devices based on RTP taken symmetrically for a set of carrier frequencies sampled symmetrically about a center time, e.g., using the techniques described below in connection with any FIGS. 3-13. The wireless device 200 may also comprise BT and/or BLE firmware or other hardware/software for controlling BT and/or BLE operations.

The wireless device 200 may be configured to implement part or all of the techniques described below in connection with any of FIGS. 3-13, e.g., by executing program instructions stored on a memory medium (e.g., a non-transitory computer-readable memory medium) and/or through hardware or firmware operation. In other embodiments, the techniques described below in connection with any of FIGS. 3-13 may be at least partially implemented by a programmable hardware element, such as an field programmable gate array (FPGA), and/or an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications, a short-range communication controller 252 configured to control short-range communications, and a WWAN controller 256 configured to control WWAN communications. In certain aspects, the wireless device 200 may store and execute a WLAN software driver for controlling WLAN operations performed by the WLAN controller 250, a short-range communication software driver for controlling short-range communication operations performed by the short-range communication controller 252, and/or a WWAN software driver for controlling WWAN operations performed by the WWAN controller 256.

In certain implementations, a first coexistence interface 254 (e.g., a wired interface) may be used for sending information between the WLAN controller 250 and the short-range communication controller 252. In certain other implementations, a second coexistence interface 258 may be used for sending information between the WLAN controller 250 and the WWAN controller 256. In certain other implementations, a third coexistence interface 260 may be used for sending information between the short-range communication controller 252 and the WWAN controller 256.

In some aspects, one or more of the WLAN controller 250, the short-range communication controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, 235d. In certain other configurations, the short-range communication controller 252 may be configured to communicate with at least one second device in a WPAN using one or more of the antennas 235a, 235b, 235c, 235d. In certain other configurations, the WWAN controller 256 may be configured to communicate with a second device in a WPAN using all of the antennas 235a, 235b, 235c, 235d. The short-range communication controller 252 may be configured to determine a distance between two devices based on RTP taken symmetrically for a set of carrier frequencies sampled symmetrically about a center time.

FIG. 3 illustrates a modified BLE protocol stack 300 that may be implemented in a BLE device in accordance with certain aspects of the present disclosure. For example, the modified BLE protocol stack 300 may be implemented by, e.g., one or more of processor(s) 202, memory 206, Flash memory 210, ROM 208, the radio 230, and/or the short-range communication controller 252 illustrated in FIG. 2.

Referring to FIG. 3, the modified BLE protocol stack 300 may be organized into three blocks, namely, the Application block 302, the Host block 304, and the Controller block 306. Application block 302 may be a user application which interfaces with the other blocks and/or layers of the modified BLE protocol stack 300. The Host block 304 may include the upper layers of the modified BLE protocol stack 300, and the Controller block 306 may include the lower layers of the modified BLE protocol stack 300.

The Host block 304 may communicate with a controller (e.g., short-range communication controller 252 in FIG. 2) in a wireless device using a Host Controller Interface (HCI) 320. The HCI 320 may also be used to interface the Controller block 306 with the Host block 304. Interfacing the Controller block 306 and the Host block 304 may enable a wide range of Hosts to interface with the Controller block 306.

The Application block 302 may include a higher-level Application Layer (App) 308, and the modified BLE protocol stack 300 may run under the App 308. The Host block 304 may include a Generic Access Profile (GAP) 310, a Generic Attribute Protocol (GATT) 312, a Security Manager (SM) 314, an Attribute Protocol (ATT) 316, and a Logical Link Control and Adaptation Protocol (L2CAP) 318, each of which are described in further detail below. The Controller block 306 may include a LL 322, a proprietary LL (QLL) 324, a Direct Test Mode (DTM) 326, and a Physical Layer (PHY) 328, each of which are described in further detail below.

To support future applications (e.g., IoT applications, audio applications, etc.), the PHY 328 of the present disclosure may support an increased range of communication and data rate as compared to the PHY in a traditional BLE protocol stack. The PHY 328 may define the mechanism for transmitting a bit stream over a physical link that connects BLE devices. The bit stream may be grouped into code words or symbols, and converted to a PDU that is transmitted over a transmission medium. The PHY 328 may provide an electrical, mechanical, and procedural interface to the transmission medium. The shapes and properties of the electrical connectors, the frequency band used for transmission, the modulation scheme, and similar low-level parameters may be specified by the PHY 328.

The DTM 326 may allow testing of the PHY 328 by transmitting and receiving sequences of test packets. DTM 326 may be used in compliance and production-line testing without the need of going through the entire modified BLE protocol stack 300. In other words, the DTM 326 may skip the Host block 304 and communicate directly with the short-range communications controller of the radio (e.g., the short-range communication controller 252 and radio 230 in FIG. 2) in an isolated manner.

The LL 322 may be responsible for low level communication over the PHY 328. The LL 322 may manage the sequence and timing of transmitted and received LL data PDUs, and using a LL protocol, communicate with other devices regarding connection parameters and data flow control. The LL 322 may provide gate keeping functionality to limit exposure and data exchange with other devices. If filtering is configured, the LL 322 may maintain a list of allowed devices and ignore all requests for data PDU exchange from devices not on the list. The LL 322 may use the HCI 320 to communicate with upper layers of the modified BLE protocol stack 300. In certain aspects, the LL 322 may be used to generate a LL data PDU and/or an empty packet (e.g., empty PDU) that may be transmitted using a LL communication link established with another BLE device using the LL 322.

The QLL 324 is a proprietary protocol that exists alongside the LL 322. The QLL 324 may be used to discover peer proprietary devices, and establish a secure communication channel therewith. For example, the QLL 324 may be used to establish a QLL communication link between short-range communication controllers and/or proprietary controllers (not shown in FIG. 2) in two wireless devices, e.g., two Qualcomm® devices, two Apple® devices, two Samsung® devices, etc. The proprietary controllers in peer proprietary devices may communicate with each other using allocated channels, a control protocol, attributes, and procedures. Proprietary controllers may either establish a QLL communication link after a standard connection at the LL 322 has been established or over an advertising bearer. Once a QLL communication link has been established at the QLL 324, the proprietary controllers of two peer proprietary devices may be able to communicate with each other using a set of dedicated channels. Each service available at a proprietary controller may be associated with a particular channel number. A proprietary controller may include up to or more than 127 different services. The services may include, e.g., firmware updates, licensing additional codes, and/or adding additional firmware components on peer devices just to name a few.

The L2CAP 318 may encapsulate multiple protocols from the upper layers into a LL data PDU and/or a QLL establishment PDU (and vice versa). The L2CAP 318 may also break large LL data PDUs and/or a QLL establishment PDUs from the upper layers into segments that fit into a maximum payload size (e.g., 27 bytes) on the transmit side. Similarly, the L2CAP 318 may receive multiple LL data PDUs and/or QLL establishment PDUs that have been segmented, and the L2CAP 318 may combine the segments into a single LL data PDU and/or a QLL establishment PDU that may be sent to the upper layers.

The ATT 316 may be a client/server protocol based on attributes associated with a BLE device configured for a particular purpose (e.g., monitoring heart rate, monitoring temperature, broadcasting advertisements, etc.). The attributes may be discovered, read, and written by other BLE enabled devices. The set of operations which are executed over ATT 316 may include, but are not limited to, error handling, server configuration, find information, read operations, write operations, queued writes, etc. The ATT 316 may form the basis of data exchange between BLE devices.

The SM 314 may be responsible for device pairing and key distribution. A security manager protocol implemented by the SM 314 may define how communications with the SM of a counterpart BLE deice are performed. The SM 314 may provide additional cryptographic functions that may be used by other components of the modified BLE protocol stack 300. The architecture of the SM 314 used in BLE may be designed to minimize recourse requirements for peripheral devices by shifting work to a central device. The SM 314 provides a mechanism to not only encrypt the data but also to provide data authentication.

The GATT 312 describes a service framework using the attribute protocol for discovering services, and for reading and writing characteristic values on a counterpart BLE device. The GATT 312 interfaces with the App 308 through the App's profile. The App 308 profile defines the collection of attributes and any permission associated with the attributes to be used in BLE communications. One of the benefits of BT technology is device interoperability. To assure interoperability, using a standardized wireless protocol to transfer bytes of information may be inadequate, and hence, sharing data representation levels may be needed. In other words, BLE devices may send or receive data in the same format using the same data interpretation based on intended device functionality. The attribute profile used by the GATT 312 may act as a bridge between the modified BLE protocol stack and the application and functionality of the BLE device (e.g., at least from a wireless connection point of view), and is defined by the profile.

The GAP 310 may provide an interface for the App 308 to initiate, establish, and manage connection with counterpart BLE devices.

Satellite positioning systems (SPSs), such as the global positioning system (GPS), have enabled navigation services for mobile handsets in outdoor environments. Likewise, particular techniques for obtaining estimates of positions of mobile device in indoor environments may enable enhanced location based services in particular indoor venues such as residential, governmental or commercial venues. For example, a range between a mobile device and a transceiver positioned at fixed location may be measured based, at least in part, on a measurement of an RSSI or an RTT measured between transmission of a first message from a first device to a second device and receipt of a second message at the first device transmitted in response to the first message.

Use of RTT and RSSI measurements for determining a distance between devices using RTT and/or RSSI measurements may lead to inaccuracies in distance estimation in band limited systems such as BT. The inaccuracies may occur in part because accuracy typically depends on determination of precise times of reception and departure in the presence of drifting clocks and complex receive chains. Accordingly, measuring a distance between devices using RTT and/or RSSI based measurements may be complex and may suffer inaccuracies in the presence of clock drift and multipath.

A distance between a first and second device may be measured based, at least in part, on multiple RTP measurements based, at least in part, on wireless tone signals transmitted between the first device and a second device. Additionally, use of multiple pairs of RTP measurements obtained with different tone signals transmitted at different carrier frequencies may enable resolving ambiguities in range measurements based on RTP measurements with tone signals transmitted at substantially the same carrier frequency.

However, when using RTP measurements with tone signals transmitted at substantially the same carrier frequency, an assumption is made that the first device and the second device are stationary, which may not always be the case. In practice, the frequency measurements may be made sequentially over a period of time and if either the first device or the second device is moving, the signal measurements (e.g., phase measurement, degree measurements, radian measurements, complex numbers, IQ data, etc.) may be made in different positions, which may corrupt the final distance estimation. In certain implementations, RTP may be used as a security measure to determine a proximity to a device, such as a laptop or car, and making an error in distance measurement to that device may lead to security risks to the user. For simplicity, signal measurements are referred to below as phase measurements. It is understood that any mention of phase measurement may include any of a signal measurement, a degree measurement, a radian measurement, a determination of a complex number, or IQ data, just to name a few.

Assuming that one device is moving at a constant radial velocity while taking a set RTP measurements for a set of carrier frequencies, the phase measured is a combination of the true distance (e.g., defined as the distance at the middle of the RTP measurement), plus additional phase that may be accumulated from the change in position. In other words, the higher the radial velocity, the larger the phase errors that may be incurred due to a larger distance moved during the set of RTP measurement.

In addition, the order in which the frequencies are sampled may change the effects of the phase accumulation. One way to collect samples across the ISM band is to start from the lowest frequency to the highest frequency, or vice versa. However, this technique may introduce errors in the distance measurement because the phase of the tone signals may be accumulated in a constructive manner when one of the devices is in motion.

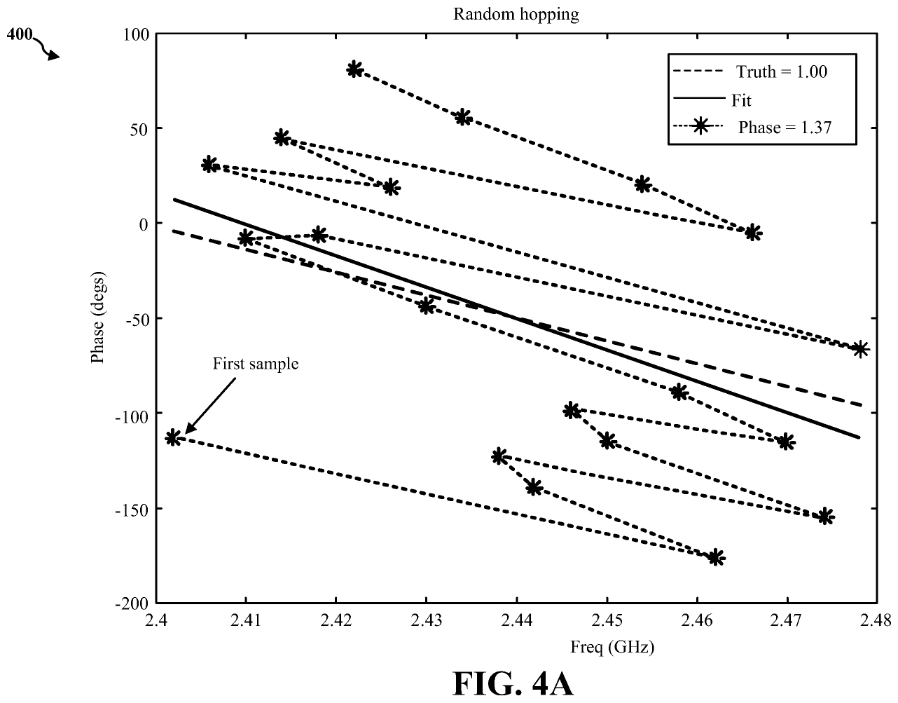

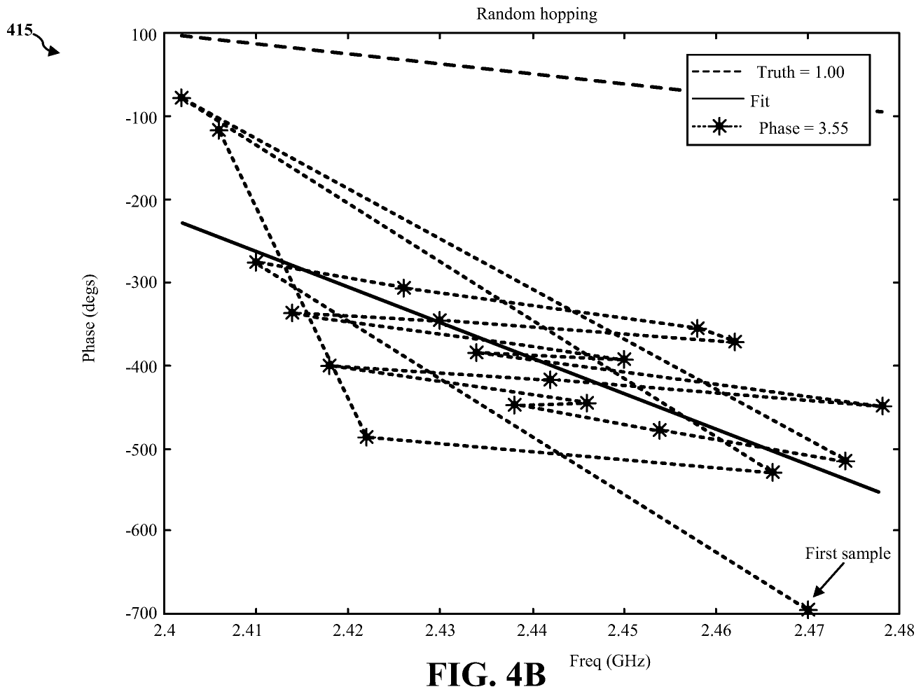

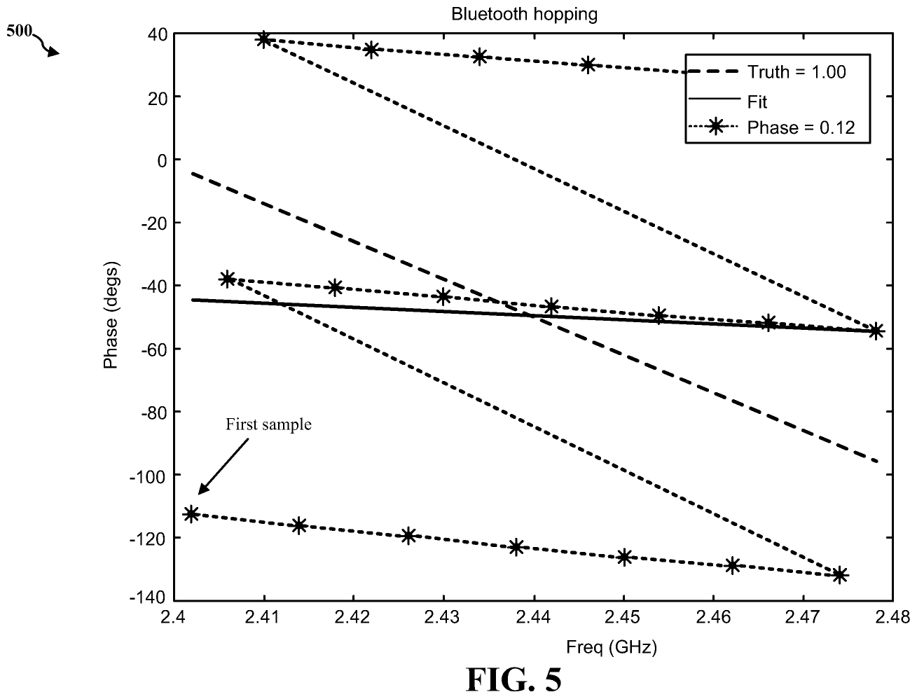

A random frequency hopping sequence or a Bluetooth hopping sequence may reduce the phase accumulation since the sequence of carrier frequencies is not monotonic. However, even using a random frequency hopping sequence or a Bluetooth hopping sequence may not completely remove errors in the distance measurement caused by radial velocity, e.g., as described below in connection to FIGS. 4A, 4B, and 5.

FIGS. 4A and 4B illustrate frequency verses phase plots 400, 415 of RTP measurements obtained using a random hopping sequence in order to simulate the effect of sampling order when determining a distance between two devices when one of the devices is moving in accordance with certain aspects of the disclosure.

The first sample collected is labeled in each of FIGS. 4A and 4B, and the connecting line shows the order in which subsequent samples were obtained. In each of FIGS. 4A and 4B, 20 RTP measurements of phase at various frequencies were obtained for use in estimating the distance between two devices. In each simulation illustrated in FIGS. 4A and 4B, the true distance between the two devices is 1 meter (e.g., assumed to be at the center of the entire RTP measurement of a set of carrier frequencies—which was obtained over 12.5 ms).

The solid line represents the fit of the data (e.g., the distance measurement obtained using the random hopping sequence), and the dashed line through the samples represents the true phase values that would obtain the actual distance between the two devices. In FIG. 4A, the fit of the samples (e.g., RTP measurements at each of the carrier frequencies) obtained using a random hopping sequence yields determined distance of 1.37 meters, which is in error of the true distance (e.g., 1 meter) by 37%. In FIG. 4B, the fit of the data using a random hopping sequence yields an estimated distance of 3.55 meters, which is in error of the true distance by 255%.

Hence, using a random hopping sequence when obtaining RTP measurements for determining a distance when one device is moving may yield an inaccurate distance measurement.

FIG. 5 illustrates a frequency verses phase plot 500 of RTP measurements obtained using a Bluetooth hopping sequence in order to simulate the effect of sampling order when determining a distance between two devices when one of the devices is moving in accordance with certain aspects of the disclosure.

The first sample collected is labeled in FIG. 5, and the connecting line shows the order in which subsequent samples were obtained. In FIG. 5, 20 RTP measurements of phase at various frequencies were obtained to measure the distance between two devices. In the simulation illustrated in FIG. 5, the true distance between the two devices is 1 meter (e.g., assumed to be at the center of the entire RTP measurement of a set of carrier frequencies—which was obtained over 12.5 ms).

The solid line represents the fit of the data (e.g., the distance measurement obtained using the Bluetooth hopping sequence), and the dashed line through the samples represents the true phase values that would obtain the actual distance between the two devices. In FIG. 5, the fit of the data obtained using a random hopping sequence yields a determined distance of 0.12 meters, which is in error of the true distance (e.g., 1 meter) by 88%.

Hence, using a Bluetooth hopping sequence when obtaining RTP measurements for determining a distance when one device is moving may yield an inaccurate distance measurement.

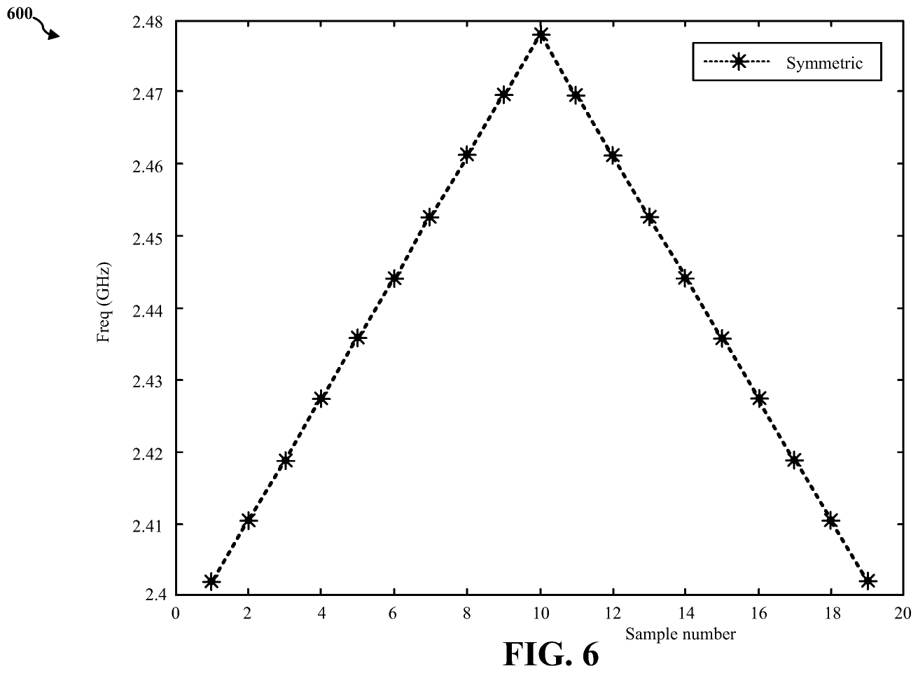

To remove the effect of phase accumulated from the radial velocity described above in connection with FIGS. 4A, 4B, and 5, the present disclosure provides a technique in which the carrier frequencies are each sampled twice symmetrically around a center time of the RTP measurement, e.g., as described in connection with FIGS. 6-13.

FIG. 6 illustrates a set of carrier frequencies 600 that may be symmetrically sampled around a center time of an RTP measurement to remove the effect of phase accumulated from a radial velocity in determining a distance measurement in accordance with certain aspects of the disclosure.

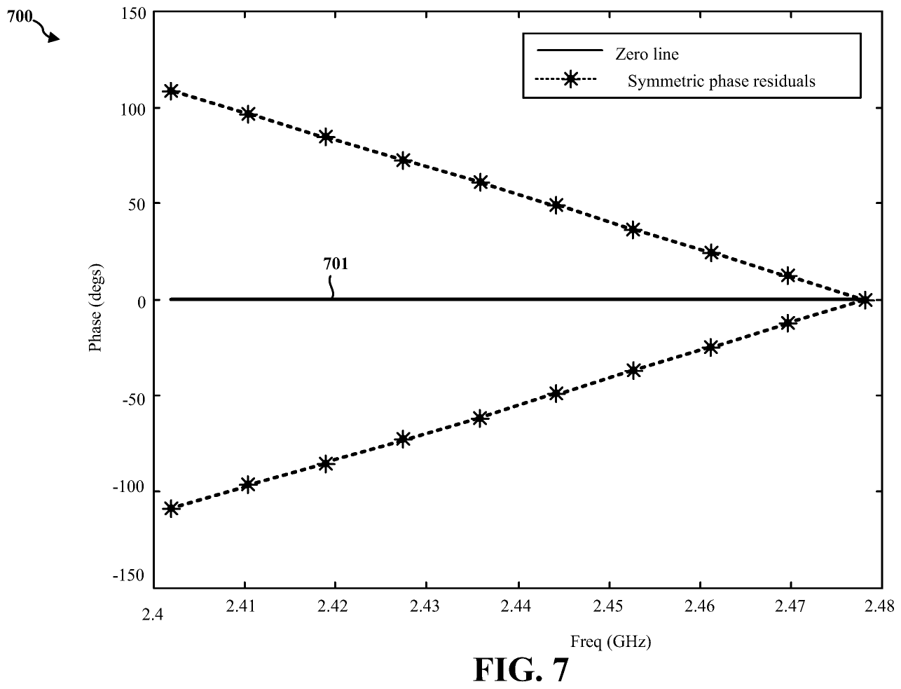

To remove the effects of phase accumulated from the radial velocity of one of the devices while obtaining RTP measurements, the carrier frequencies may be sampled twice symmetrically around the center time of the RTP measurement as illustrated in FIG. 6 and described below in more detail in connection with FIGS. 7-13.

FIG. 7 illustrates a set of carrier frequencies 700 that may be symmetrically sampled around a center time of an RTP measurement to remove the effect of phase accumulated from a radial velocity in determining a distance measurement in accordance with certain aspects of the disclosure.

To remove the effects of phase accumulated from the radial velocity of one of the devices while obtaining RTP measurements, the carrier frequencies may be sampled twice symmetrically around the center time 701 of the RTP measurement. Because phase changes linearly with time, symmetrically sampling each carrier frequency twice about the center time 701 of the RTP measurements may cancel out any gains and/or losses of phase due to the radial velocity.

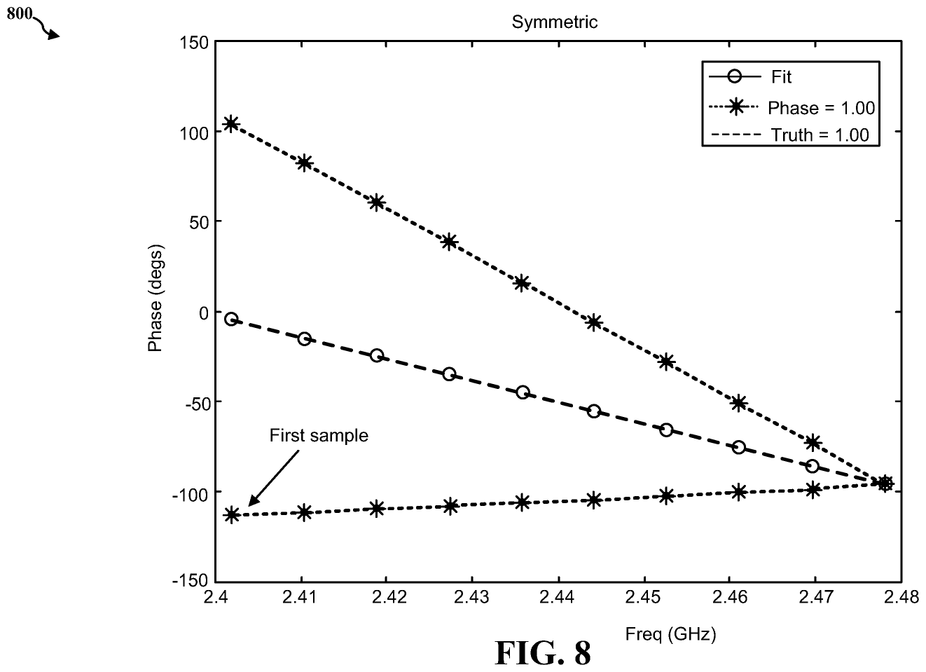

FIG. 8 illustrates a set of carrier frequencies 800 that may be symmetrically sampled around the center time of an RTP measurement to remove the effect of phase accumulated from a radial velocity in determining a distance measurement in accordance with certain aspects of the disclosure.

In FIG. 8, the first and second device sample a carrier frequency starting at the bottom left of the plot and moving to the right by sending and receiving tone signals at each carrier frequency (e.g., from the lowest to the highest) until the center time of the RTP measurement.

Once the center of the RTP measurement is reached, the first and second device take a symmetric sampling for the same carrier frequency starting from the rightmost carrier frequency seen in FIG. 8 and moving towards the left until the symmetric sample of the set of carrier frequencies is complete.

The symmetric sampling of the carrier frequencies may allow any phase gained and/or lost by radial motion of at least one of the devices to be canceled out. The line fit in FIG. 8 yields a distance measurement of 1 meter, which is the actual distance between the first and second device at the end of the RTP measurement.

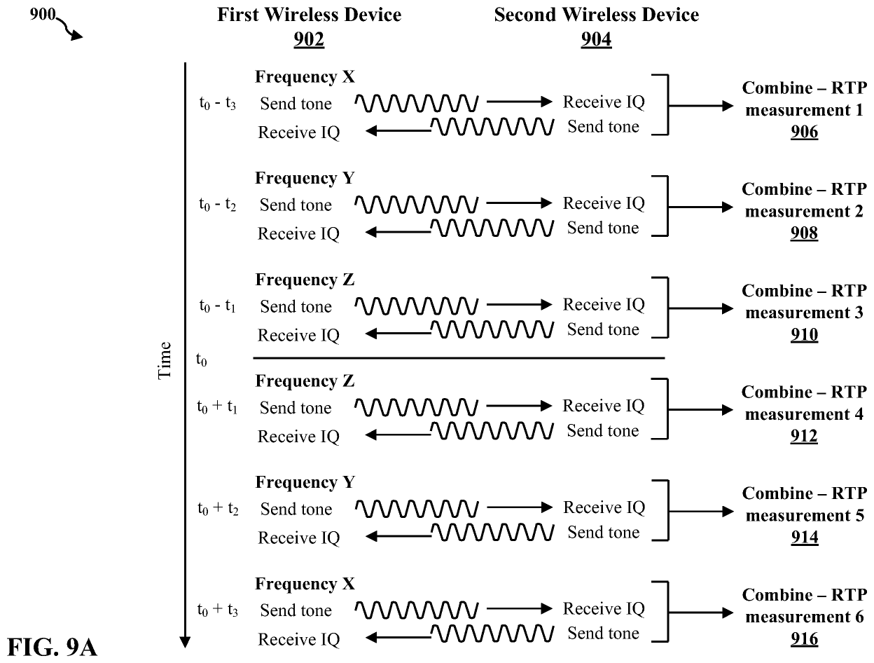

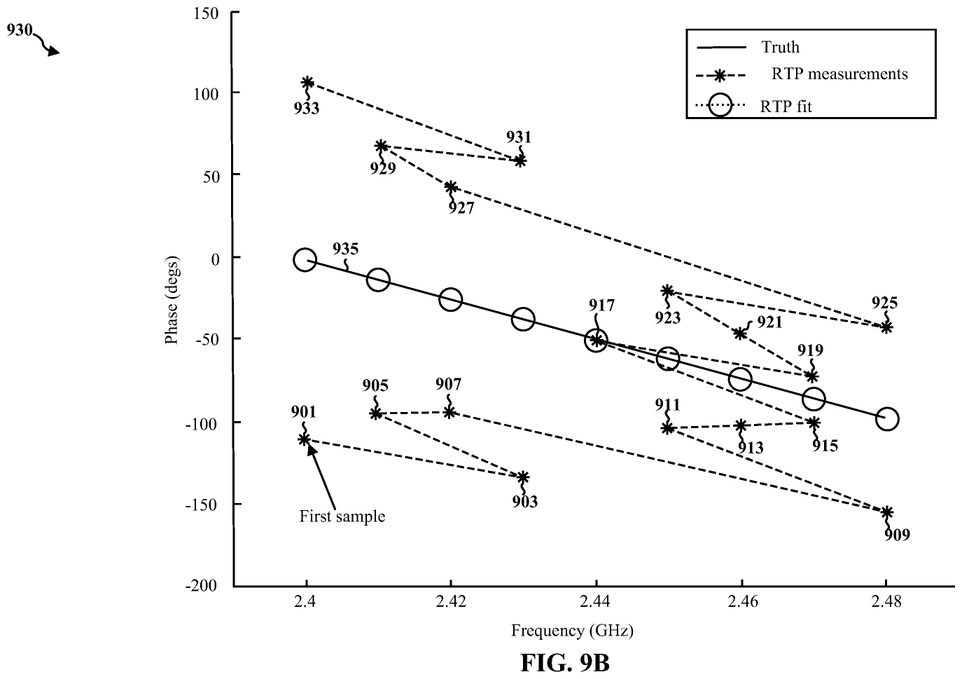

FIG. 9A illustrates a set of carrier frequencies 900 (e.g., Fx, Fy, Fz) that may be symmetrically sampled around the center time of an RTP measurement to remove the effect of phase accumulated from a radial velocity while determining a distance measurement in accordance with certain aspects of the disclosure. In FIG. 9A, Fx, Fy, Fz may be carrier frequencies that are in ascending or descending order in the frequency domain (e.g., Fx=2.40 GHz, Fy=2.45 GHz, Fz=2.47 GHz), are in partially ascending or descending order in the frequency domain (e.g., Fx=2.42 GHz, Fy=2.43 GHz, Fz=2.40 GHz), or are not in ascending or descending order in the frequency domain (e.g., Fx=2.40 GHz, Fy=2.45 GHz, Fz=2.43 GHz).

An RTP measurement according to the present disclosure may include multiple signal measurements Fx, Fy, Fz, and a signal measurement may include both the first wireless device 902 and the second wireless device 904 sending and receiving a tone at each of the carrier frequencies and collecting in-phase and quadrature (IQ) data to be combined (at 906) for Fx before t₀, combined (at 908) for Fy before t₀, combined (at 910) for Fz before t₀, combined (at 912) for Fz after t₀, combined (at 914) for Fy after t₀, and combined (at 916) for Fx after t₀ to obtain an IQ value or RTP measurement for a particular carrier frequency. In certain configurations, IQ data may be determined once all of the frequencies Fx, Fy, Fz have been sampled before and after t₀, where t₀ is the RTP measurement campaign center time.

For example, FIG. 9A illustrates an example of how an RTP measurement campaign may be made. An RTP measurement campaign may include sampling of carrier frequencies Fx, Fy, Fz both before and after to to determine RTP measurements that may be used in fitting a line to estimate a distance between the first wireless device 902 and the second wireless device 904. In the example illustrated in FIG. 9A, the sampled carrier frequencies Fx, Fy and Fz may have arbitrary values but the order in which Fx, Fy, and Fz are sampled is symmetric in time around t₀ (e.g., the RTP measurement campaign center time). For example, the first wireless device 902 my sample a set of carrier frequencies (e.g., Fx, Fy, Fz) in a first order before t₀, and the wireless device 902 may sample the same set of carrier frequencies (e.g., Fz, Fy, Fx) in reverse after t₀.

As seen in FIG. 9A, before t₀, the first wireless device 902 may transmit a signal using Fx at time t₀−t₃, receive a signal from the second wireless device 904 using Fx at time t₀−t₃, transmit a signal using Fy at time t₀−t₂, receive a signal from the second wireless device 904 using Fy at time t₀−t₂, transmit a signal using Fz at time t₀−t₁, and receive a signal from the second wireless device using Fz at time t₀−t₁. After t₀, the first wireless device 902 may transmit a signal using Fz at time t₀+t₁, receive a signal from the second wireless device 904 using Fz at time t₀+t₁, transmit a signal using Fy at time t₀+t₁, receive a signal from the second wireless device 904 using Fy at time t₀+t₂, transmit a signal Fx at time t₀+t₃, and receive a signal from the second wireless device using Fx at time t₀+t₃.

In certain implementations, the difference between t₀ and t₁, t₁ and t₂, and t₂ and t₃ may be the same. In certain other implementations, the difference between at least one of t₀ and t₁, t₁ and t₂, and t₂ and t₃ may be different.

The first wireless device 902 may use the repeated measurement of the same set of carrier frequency symmetrically about t₀ may be used to more accurately determine the distance to the second wireless device 904 than by using a random hopping sequence and/or a Bluetooth frequency hopping sequence.

By obtaining RTP measurements for each carrier frequency symmetrically about t₀, the first wireless device 902 may eliminate motion artifacts that may otherwise negatively affect the accuracy of the distance measurement between the first wireless device 902 and the second wireless device 904. Motion artifacts may negatively affect the accuracy of the distance measurement when using a random hopping sequence or a Bluetooth hopping sequence described above in connection with FIGS. 4A, 4B, and 5, but may be eliminated when using the symmetric frequency sequence described with respect to FIGS. 6-13.

For example, each RTP measurement of a particular carrier frequency (e.g., Fx, Fy, or Fz) may be used to determine an IQ value that takes the mathematical form of e^{i(ω(t}^{₀}^{+δt))}=e^{i(2πF(t}^{₀}^{+t}ᵢ⁾⁾. The mathematical form of the IQ value for each RTP measurement may have a phase value of θ=θₜ_{₀}+θ_{δt}=∠e^{i(ω(t}^{₀}^{δt))}, where ω=2πF and δt=tᵢ. The final IQ value obtained for each of Fx, Fy, and Fz may be determined using a summation of the two the IQ values for a carrier frequency determined before and after to may be the same IQ value that would be determined if the carrier frequency was sampled exactly at t₀, as described below in equation 1, where A=2 cos(−ωδt).

$$\begin{matrix}{e}^{i ( ω ( {t}_{0} - δ t ) )} + {e}^{i ( ω ( {t}_{0} + δ t ) )} = cos ( ω ( {t}_{0} - δ t ) ) + i sin ( ω ( {t}_{0} - δ t ) ) + \\ cos ( ω ( {t}_{0} + δ t ) ) + i sin ( ω ( {t}_{0} + δ t ) ) \\ = ( cos ( ω ( {t}_{0} - δ t ) ) + cos ( ω ( {t}_{0} + δ t ) ) ) + \\ i ( sin ( ω ( {t}_{0} - δ t ) ) + sin ( ω ( {t}_{0} + δ t ) ) ) \\ = ( 2 cos \begin{matrix}\frac{ω ( {t}_{0} - δ t ) + ω ( {t}_{0} + δ t )}{2} cos \\ \frac{ω ( {t}_{0} - δ t ) - ω ( {t}_{0} + δ t )}{2}\end{matrix} ) + \\ i ( 2 sin \begin{matrix}\frac{ω ( {t}_{0} - δ t ) + ω ( {t}_{0} + δ t )}{2} cos \\ \frac{ω ( {t}_{0} - δ t ) - ω ( {t}_{0} + δ t )}{2}\end{matrix} ) \\ = ( 2 cos ( ω {t}_{0} ) cos ( - ω δ t ) ) + \\ i ( 2 sin ( ω {t}_{0} ) cos ( - ωδ t ) ) \\ = A ( cos ( ω {t}_{0} ) + i sin ( ω {t}_{0} ) ) \\ = A {e}^{i ( ω {t}_{0} )}\end{matrix}$$

### Equation 1—Final IQ Value Using a Summation of Corresponding Pairs of Carrier Frequency Measurements Taken Before and After t₀

Certain identities associated with equation 1 may include

$$sin x + sin y = 2 sin \frac{x + y}{2} cos \frac{x - y}{2} and$$

$$cos x + cos y = 2 cos \frac{x + y}{2} cos \frac{x - y}{2} .$$

Furthermore, the term A in equation 1 may not affect the phase measurements used in determining the final IQ value for corresponding pairs of carrier frequency measurement sampled both before and after t₀.

In an alternative or additional implementation, the first wireless device 902 may obtain the final IQ value by averaging two corresponding measurements of a particular carrier frequency obtained before to and after to as seen below in equation 2.

$$\frac{∠ {e}^{i ( ω ( {t}_{0} - δ t ) )} + ∠ {e}^{i ( ω ( {t}_{0} + δ t ) )}}{2} = \frac{( {θ}_{{t}_{0}} - {θ}_{δ t} ) + ( {θ}_{{t}_{0}} + {θ}_{δ t} )}{2} = {θ}_{{t}_{0}}$$

### Equation 2—Final IQ Value Using an Average of Corresponding Pairs of Carrier Frequency Measurements Taken Before and After t₀

In other words, there may be different ways that the data (e.g., IQ values, RTP measurements, signal measurements, degree measurements, radian measurements, complex numbers, etc.) may be sampled by the first wireless device 902 such that the effects of radial velocity are canceled out when a line fit of the data is performed. For example, assuming a fixed radial velocity (V), time (T), and distance (D) may be interchangeable in the equations 1 and 2 seen above because V=D/T.

FIG. 9B illustrates a frequency verses phase plot 930 of RTP measurements obtained using a symmetric frequency sequence in order to simulate the effect of sampling order when determining a distance between two devices when one of the devices is moving in accordance with certain aspects of the disclosure.

The first sample collected is labeled in FIG. 9B, and the connecting line shows the order in which subsequent RTP measurements 901, 903, 905, 907, 909, 911, 913, 915, 917, 919, 921, 923, 925, 927, 929, 931, 933 for various carrier frequencies before, after, and at to were obtained.

For example, before t₀, the wireless device (e.g., the first wireless device 902 or the second wireless device 904 in FIG. 9A) may determine the RTP measurement 901 for the 2.40 GHz carrier frequency at t₀−t₈, the wireless device may determine the RTP measurement 903 for the 2.43 GHz carrier frequency at t₀−t₇, the wireless device may determine the RTP measurement 905 for the 2.41 GHz carrier frequency at t₀−t₆, the wireless device may determine the RTP measurement 907 for the 2.42 GHz carrier frequency at t₀−t₅, the wireless device may determine the RTP measurement 909 for the 2.48 GHz carrier frequency at t₀−t₄, the wireless device may determine the RTP measurement 911 for the 2.45 GHz carrier frequency at t₀−t₃, the wireless device may determine the RTP measurement 913 for the 2.46 GHz carrier frequency at t₀−t₂, and the wireless device may determine the RTP measurement 913 for the 2.47 GHz carrier frequency at t₀−t₁.

At t₀, the wireless device may determine an RTP measurement for 917 for the 2.44 GHz carrier frequency. Because the RTP measurement 917 for the 2.44 GHz carrier frequency is determined at t₀, a single sample of the 2.44 GHz carrier frequency may be used in determining the distance between the two wireless device.

After t₀, the wireless device may sample the same set of carrier frequencies that were sampled before t₀, however, the set of carrier frequencies may be sampled in reverse order after to in order. For example, the wireless device may determine the RTP measurement 919 for the 2.47 GHz carrier frequency at t₀+t₁, the wireless device may determine the RTP measurement 921 for the 2.46 GHz carrier frequency at t₀+t₂, the wireless device may determine the RTP measurement 923 for the 2.45 GHz carrier frequency at t₀+t₃, the wireless device may determine the RTP measurement 925 for the 2.48 GHz carrier frequency at t₀+t₄, the wireless device may determine the RTP measurement 927 for the 2.42 GHz carrier frequency at t₀+t₅, the wireless device may determine the RTP measurement 929 for the 2.41 GHz carrier frequency at t₀+t₆, the wireless device may determine the RTP measurement 931 for the 2.43 GHz carrier frequency at t₀+t₇, and the wireless device may determine the RTP measurement 933 for the 2.40 GHz carrier frequency at t₀+t₈.

The solid line 935 represents the fit line of the data (e.g., the distance measurement obtained using the symmetric frequency sequence), which corresponds to the true phase values that would yield the actual distance between the first wireless device and the second wireless device. In FIG. 9B, the gradient of the best fit line of the data obtained using a symmetric frequency sequence yields a determined distance of 1 meter, which is in fact the true distance between the first wireless device and the second wireless device in FIG. 9B.

Hence, by obtaining samples for each carrier frequency symmetrically about t₀ for RTP measurements, motion artifacts that may otherwise negatively affect the accuracy of the distance measurement between two wireless device may be eliminated.

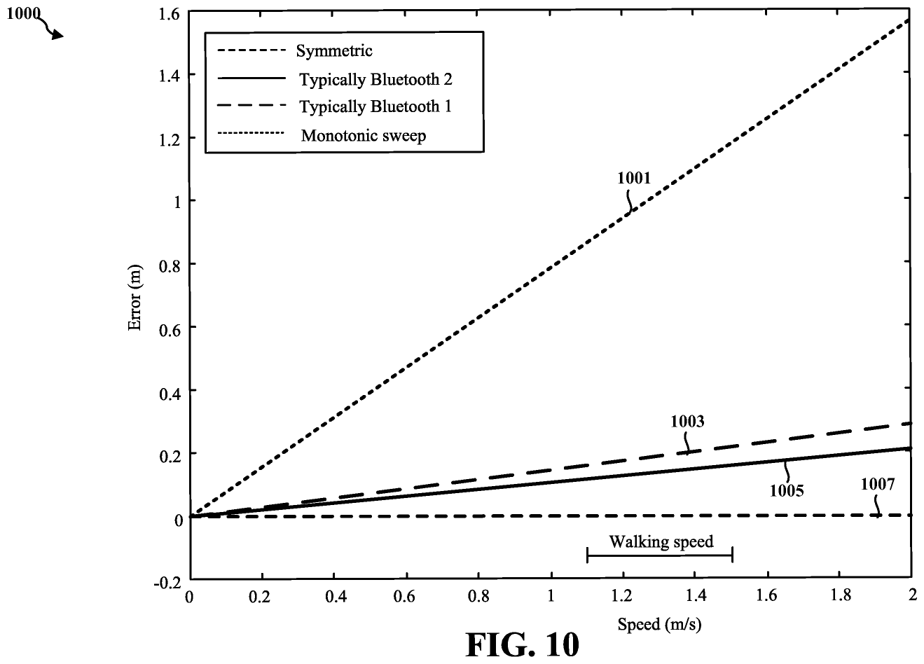

FIG. 10 illustrates a graphical plot of absolute errors 1000 that are accumulated in a distance measurement between two devices while one device is in motion using a monotonic sweep 1001, a first Bluetooth hopping sequence 1003, a second Bluetooth hopping sequence 1005, and symmetric frequency sequence 1007 in accordance with certain aspects of the disclosure.

As illustrated in FIG. 10, the monotonic sweep 1001 yields the largest absolute error in the distance measurement, the first Bluetooth hopping sequence 1003 yields the second largest absolute error in the distance measurement, and the second Bluetooth hopping sequence 1005 yields the third largest absolute error in the distance measurement. The difference in the amount of absolute error between the distance measurements for the first Bluetooth hopping sequence 1003 and the second Bluetooth hopping sequence 1005 may vary depending on the carrier frequency initially sampled and the frequency hopping step size.

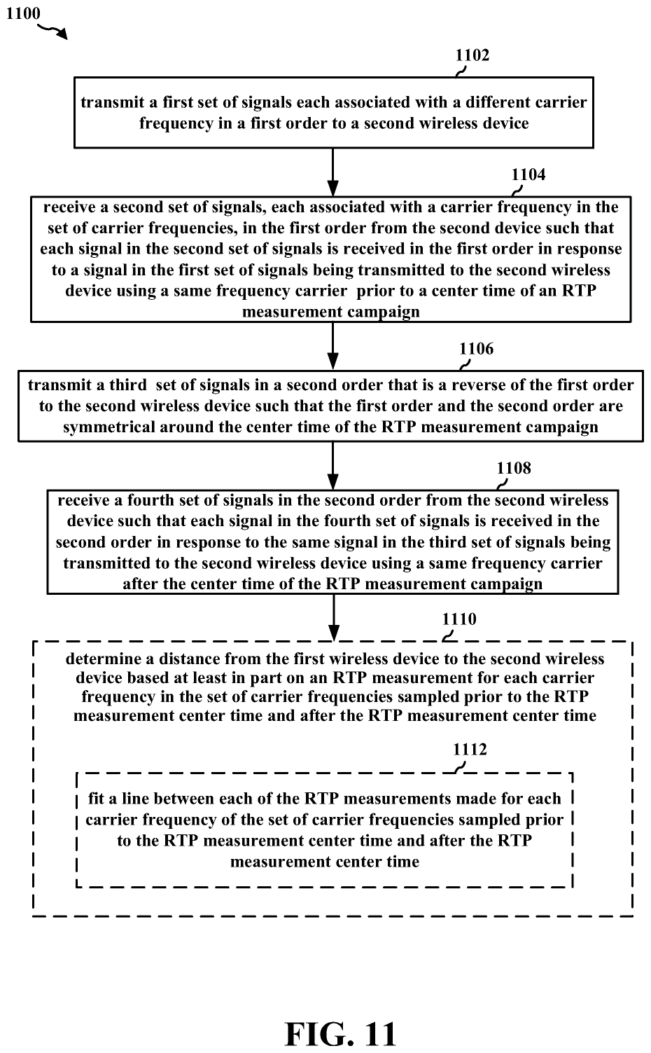

As also illustrated in FIG. 10, there is zero error in the distance measurement obtained using the symmetric frequency sequence 1007 (e.g., the RTP measurement campaign) described above in connection with 6-9 and further described below in connection with FIGS. 11-13.

FIG. 11 is a flowchart 1100 of a method of wireless communication. The method may be performed by a first wireless device (e.g., the central device 102, peripheral device 104, 106, 108, 110, 112, the wireless device 200, the first wireless device 902, the apparatus 1202/1202′). In FIG. 11, optional operations may be indicated with a dashed line.

At 1102, the first wireless device may transmit a first set of signals in a first order to a second wireless device. In certain aspects, each signal in the first set of signals may be associated with a different carrier frequency of a set of carrier frequencies. For example, referring to FIG. 9A, before t₀, the first wireless device 902 may transmit a signal using Fx at time t₀−t₃, transmit a signal using Fy at time t₀−t₂, and transmit a signal using Fz at time t₀−t₁.

At 1104, the first wireless device may receive a second set of signals in the first order from the second wireless device. In certain aspects, each signal in the second set of signals may be associated with a carrier frequency in the set of carrier frequencies. In certain other aspects, each signal in the second set of signals may be received in the first order in response to a signal in the first set of signals being transmitted to the second wireless device using a same carrier frequency prior to a round-trip phase (RTP) measurement center time. In certain other aspects, the RTP measurement center time may be a center time of an RTP measurement campaign. For example, referring to FIG. 9A, before t₀, the first wireless device 902 may receive a signal from the second wireless device 904 using Fx at time t₀−t₃, receive a signal from the second wireless device 904 using Fy at time t₀−t₂, and receive a signal from the second wireless device using Fz at time t₀−t₁.

At 1106, the first wireless device may transmit a third set of signals in a second order to the second wireless device. In certain aspects, the second order may be a reverse of the first order. In certain other aspects, the first order and the second order may be symmetrical around the RTP measurement center time. In certain other aspects, each signal in the third set of signals may be associated with a carrier frequency in the set of carrier frequencies. For example, referring to FIG. 9A, after t₀, the first wireless device 902 may transmit a signal using Fz at time t₀+t₁, transmit a signal using Fy at time t₀+t₁, and transmit a signal Fx at time t₀+t₃.

At 1108, the first wireless device may receive a fourth set of signals in the second order from the second wireless device. In certain aspects, each signal in the fourth set of signals may be received in the second order in response to a signal in the third set of signals being transmitted to the second wireless device using a same carrier frequency after the RTP measurement center time. In certain other aspects, each signal in the fourth set of signals may be associated with a carrier frequency in the set of carrier frequencies. For example, referring to FIG. 9A, after t₀, the first wireless device 902 may receive a signal from the second wireless device 904 using Fz at time t₀+t₁, receive a signal from the second wireless device 904 using Fy at time t₀+t₂, and receive a signal from the second wireless device using Fx at time t₀+t₃.

At 1110, the first wireless device may determine a distance from the first wireless device to the second wireless device based at least in part on an RTP measurement for each carrier frequency in the set of carrier frequencies sampled prior to the RTP measurement center time and after the RTP measurement center time. For example, referring to FIGS. 9A and 9B, the first wireless device 902 may determine the distance between the first wireless device 902 and the second wireless device 904 based at least in part on one or more of the RTP measurements made before and after t₀.

At 1112, the first wireless device may determine the distance from the first wireless device to the second wireless device by fitting a line between each of the RTP measurements made for each carrier frequency of the set of carrier frequencies sampled prior to the RTP measurement center time and after the RTP measurement center time. For example, referring to FIG. 9B, the solid line 935 represents the fit line of the data (e.g., the distance measurement obtained using the symmetric frequency sequence), which corresponds to the true phase values that would yield the actual distance between the first wireless device and the second wireless device. In FIG. 9B, the gradient of the best fit line of the data obtained using a symmetric frequency sequence yields determined distance of 1 meter, which is in fact the true distance between the first wireless device and the second wireless device.

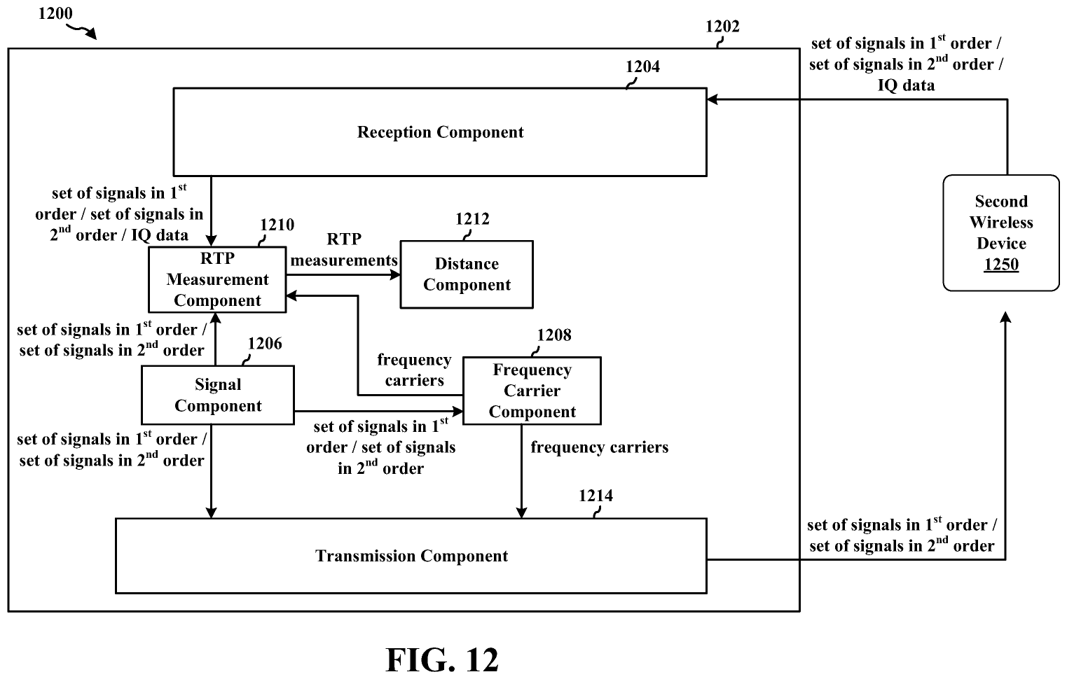

FIG. 12 is a conceptual data flow diagram 1200 illustrating the data flow between different means/components in an exemplary apparatus 1202. The apparatus may be a first wireless device (e.g., the central device 102, peripheral device 104, 106, 108, 110, 112, the wireless device 200, the apparatus 1202/1202′) that is in communication with a second wireless device 1250 (e.g., the central device 102, peripheral device 104, 106, 108, 110, 112, the wireless device 200). The apparatus includes a reception component 1204, a signal component 1206, a carrier frequency component 1208, an RTP measurement component 1210, a distance component 1212, and a transmission component 1214.

The signal component 1206 may be configured to generate a first set of signals (e.g., transmitted at each carrier frequency before t₀) for transmission to the second wireless device 1250 and a third set of signals (e.g., transmitted at each carrier frequency after t₀) for transmission to the second wireless device 1250. The signal component 1206 may be configured to transmit information (e.g., phase information associated with the set of signals) to the carrier frequency component 1208, the RTP measurement component 1210, and/or the transmission component 1214. In certain configurations, the signal component 1206 may be an oscillator that oscillates a carrier signal. When the signal component 1206 includes an oscillator, the oscillator may be configured to oscillate the signals for each of the first set of signals and the third set of signals for a respective carrier frequency.

The carrier frequency component 1208 may be configured to generate information about the carrier frequencies used to transmit the first set of signals and the third set of signals. The carrier frequency component 1208 may be configured to send the information about the carrier frequencies to the transmission component 1214 and/or the RTP measurement component 1210.

The transmission component 1214 may be configured to transmit a first set of signals in a first order to a second wireless device. In certain aspects, each signal in the first set of signals may be associated with a different carrier frequency of a set of carrier frequencies, e.g., as described in connection with 1102 in FIG. 11.

The reception component 1204 may be configured to receive a second set of signals in the first order from the second wireless device. In certain aspects, each signal in the second set of signals may be associated with a carrier frequency in the set of carrier frequencies. In certain other aspects, each signal in the second set of signals may be received in the first order in response to a signal in the first set of signals being transmitted to the second wireless device using a same carrier frequency prior to an RTP measurement center time. In certain other aspects, the RTP measurement center time may be a center time of an RTP measurement campaign. The reception component 1204 may be configured to send the second set of signals to the RTP measurement component 1210.

The transmission component 1214 may be configured to transmit a third set of signals in a second order to the second wireless device 1250. In certain aspects, the second order may be a reverse of the first order. In certain other aspects, the first order and the second order may be symmetrical around the RTP measurement center time. In certain other aspects, each signal in the third set of signals may be associated with a carrier frequency in the set of carrier frequencies.

The reception component 1204 may be configured to receive a fourth set of signals in the second order from the second wireless device. In certain aspects, each signal in the fourth set of signals may be received in the second order in response to a signal in the third set of signals being transmitted to the second wireless device using a same carrier frequency after the RTP measurement center time. In certain other aspects, each signal in the fourth set of signals may be associated with a carrier frequency in the set of carrier frequencies. The reception component 1204 may be configured to send the fourth set of signals to the RTP measurement component 1210. In certain aspects, the reception component 1204 may be configured to receive a signal measurements (e.g., phase measurements, IQ data, degree measurements, radian measurements, complex number information, etc.) associated with the phase difference determined by the second wireless device 1250 for each of the sampled carrier frequencies before and after the RTP center time. The signal information may be sent to the RTP measurement component 1210.

The RTP measurement component 1210 may be configured to determine an RTP measurement for each carrier frequency before the RTP measurement center time and for each carrier frequency after the RTP measurement center time. The RTP measurement component 1210 may be configured to send information related to the RTP measurements to the distance component 1212.

The distance component 1212 may be configured to determine a distance from the first wireless device 1202 to the second wireless device 1250 based at least in part on an RTP measurement for each carrier frequency in the set of carrier frequencies sampled prior to the RTP measurement center time and after the RTP measurement center time. The signal information received from the second wireless device 1250 may also be used in determining the distance. In certain configurations, the distance component 1212 may be configured to determine the distance from the first wireless device to the second wireless device 1250 by fitting a line between each of the RTP measurements made for each carrier frequency of the set of carrier frequencies sampled prior to the RTP measurement center time and after the RTP measurement center time.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

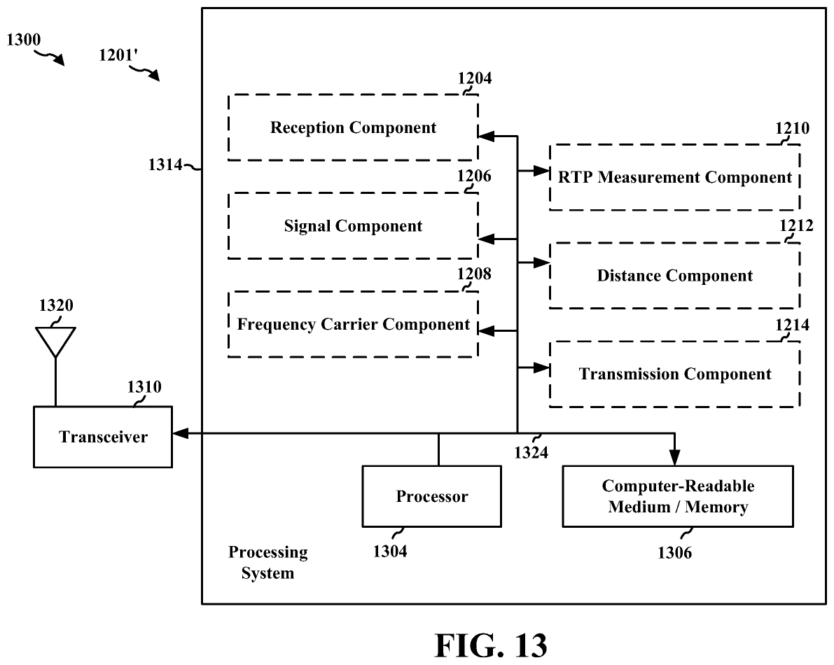

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, 1210, 1212, 1214, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1214, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208, 1210, 1212, 1214. The components may be software components running in the processor 1304, resident/stored in the computer readable medium/memory 1306, one or more hardware components coupled to the processor 1304, or some combination thereof.

In certain configurations, the apparatus 1202/1202′ for wireless communication may include means for transmitting a first set of signals in a first order to a second wireless device. In certain aspects, each signal in the first set of signals may be associated with a different carrier frequency of a set of carrier frequencies.

In certain other configurations, the apparatus 1202/1202′ for wireless communication may include means for receiving a second set of signals in the first order from the second wireless device. In certain aspects, each signal in the second set of signals may be associated with a carrier frequency in the set of carrier frequencies. In certain other aspects, each signal in the second set of signals may be received in the first order in response to a signal in the first set of signals being transmitted to the second wireless device using a same carrier frequency prior to an RTP measurement center time. In certain other aspects, the RTP measurement center time may be a center time of an RTP measurement campaign.

In certain other configurations, the apparatus 1202/1202′ for wireless communication may include means for transmitting a third set of signals in a second order to the second wireless device. In certain aspects, the second order may be a reverse of the first order. In certain other aspects, the first order and the second order may be symmetrical around the RTP measurement center time. In certain other aspects, each signal in the third set of signals may be associated with a carrier frequency in the set of carrier frequencies.

In certain implementations, the apparatus 1202/1202′ for wireless communication may include means for receiving a fourth set of signals in the second order from the second wireless device. In certain aspects, each signal in the fourth set of signals may be received in the second order in response to a signal in the third set of signals being transmitted to the second wireless device using a same carrier frequency after the RTP measurement center time. In certain other aspects, each signal in the fourth set of signals may be associated with a carrier frequency in the set of carrier frequencies.

In certain implementations, the apparatus 1202/1202′ for wireless communication may include means for determining a distance from the first wireless device to the second wireless device based at least in part on an RTP measurement for each carrier frequency in the set of carrier frequencies sampled prior to the RTP measurement center time and after the RTP measurement center time.

In certain implementations, the means for determining the distance from the first wireless device to the second wireless device may be configured to fit a line between each of the RTP measurements made for each carrier frequency of the set of carrier frequencies sampled prior to the RTP measurement center time and after the RTP measurement center time.

The aforementioned means may be the processor(s) 202, the radio 230, the MMU 240, short-range communication controller 252, one or more of the aforementioned components of the apparatus 1202 and/or the processing system 1314 of the apparatus 1202′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a first wireless device, comprising:
transmitting a first set of signals in a first order to a second wireless device, each signal in the first set of signals being associated with a different carrier frequency of a set of carrier frequencies;
receiving a second set of signals in the first order from the second wireless device, each signal in the second set of signals being associated with a carrier frequency in the set of carrier frequencies, each signal in the second set of signals being received in the first order in response to a signal in the first set of signals being transmitted to the second wireless device using a same carrier frequency prior to a round-trip phase (RTP) measurement center time, the RTP measurement center time being a center time of an RTP measurement campaign;
transmitting a third set of signals in a second order to the second wireless device, the second order being a reverse of the first order, the first order and the second order being symmetrical around the RTP measurement center time, and each signal in the third set of signals being associated with a carrier frequency in the set of carrier frequencies;
receiving a fourth set of signals in the second order from the second wireless device, each signal in the fourth set of signals being received in the second order in response to a signal in the third set of signals being transmitted to the second wireless device using a same carrier frequency after the RTP measurement center time, and each signal in the fourth set of signals being associated with a carrier frequency in the set of carrier frequencies;
determining a distance from the first wireless device to the second wireless device based at least in part on an RTP measurement for each carrier frequency in the set of carrier frequencies sampled prior to the RTP measurement center time and after the RTP measurement center time; and
wherein the determining the distance from the first wireless device to the second wireless device comprises:
fitting a line between each of the RTP measurements made for each carrier frequency of the set of carrier frequencies sampled prior to the RTP measurement center time and after the RTP measurement center time.

2. (canceled)

3. (canceled)

4. An apparatus for wireless communication of a first wireless device, comprising:
means for transmitting a first set of signals in a first order to a second wireless device, each signal in the first set of signals being associated with a different carrier frequency of a set of carrier frequencies;
means for receiving a second set of signals in the first order from the second wireless device, each signal in the second set of signals being associated with a carrier frequency in the set of carrier frequencies, each signal in the second set of signals being received in the first order in response to a signal in the first set of signals being transmitted to the second wireless device using a same carrier frequency prior to a round-trip phase (RTP) measurement center time, the RTP measurement center time being a center time of an RTP measurement campaign;
means for transmitting a third set of signals in a second order to the second wireless device, the second order being a reverse of the first order, the first order and the second order being symmetrical around the RTP measurement center time, and each signal in the third set of signals being associated with a carrier frequency in the set of carrier frequencies;
means for receiving a fourth set of signals in the second order from the second wireless device, each signal in the fourth set of signals being received in the second order in response to a signal in the third set of signals being transmitted to the second wireless device using a same carrier frequency after the RTP measurement center time, and each signal in the fourth set of signals being associated with a carrier frequency in the set of carrier frequencies;
means for determining a distance from the first wireless device to the second wireless device based at least in part on an RTP measurement for each carrier frequency in the set of carrier frequencies sampled prior to the RTP measurement center time and after the RTP measurement center time; and
wherein the means for determining the distance from the first wireless device to the second wireless device is configured to:
fit a line between each of the RTP measurements made for each carrier frequency of the set of carrier frequencies sampled prior to the RTP measurement center time and after the RTP measurement center time.

5. (canceled)

6. (canceled)

7. An apparatus for wireless communication of a first wireless device, comprising:
a memory; and
at least one processor coupled to the memory and configured to:
transmit a first set of signals in a first order to a second wireless device, each signal in the first set of signals being associated with a different carrier frequency of a set of carrier frequencies;
receive a second set of signals in the first order from the second wireless device, each signal in the second set of signals being associated with a carrier frequency in the set of carrier frequencies, each signal in the second set of signals being received in the first order in response to a signal in the first set of signals being transmitted to the second wireless device using a same carrier frequency prior to a round-trip phase (RTP) measurement center time, the RTP measurement center time being a center time of an RTP measurement campaign;
transmit a third set of signals in a second order to the second wireless device, the second order being a reverse of the first order, the first order and the second order being symmetrical around the RTP measurement center time, and each signal in the third set of signals being associated with a carrier frequency in the set of carrier frequencies;
receive a fourth set of signals in the second order from the second wireless device, each signal in the fourth set of signals being received in the second order in response to a signal in the third set of signals being transmitted to the second wireless device using a same carrier frequency after the RTP measurement center time, and each signal in the fourth set of signals being associated with a carrier frequency in the set of carrier frequencies;
determine a distance from the first wireless device to the second wireless device based at least in part on an RTP measurement for each carrier frequency in the set of carrier frequencies sampled prior to the RTP measurement center time and after the RTP measurement center time; and
wherein the at least one processor is configured to determine the distance from the first wireless device to the second wireless device by:
fitting a line between each of the RTP measurements made for each carrier frequency of the set of carrier frequencies sampled prior to the RTP measurement center time and after the RTP measurement center time.

8. (canceled)

9. (canceled)

10. A non-transitory computer-readable medium storing computer executable code of a first wireless device, comprising code to:
transmit a first set of signals in a first order to a second wireless device, each signal in the first set of signals being associated with a different carrier frequency of a set of carrier frequencies;
receive a second set of signals in the first order from the second wireless device, each signal in the second set of signals being associated with a carrier frequency in the set of carrier frequencies, each signal in the second set of signals being received in the first order in response to a signal in the first set of signals being transmitted to the second wireless device using a same carrier frequency prior to a round-trip phase (RTP) measurement center time, the RTP measurement center time being a center time of an RTP measurement campaign;
transmit a third set of signals in a second order to the second wireless device, the second order being a reverse of the first order, the first order and the second order being symmetrical around the RTP measurement center time, and each signal in the third set of signals being associated with a carrier frequency in the set of carrier frequencies;
receive a fourth set of signals in the second order from the second wireless device, each signal in the fourth set of signals being received in the second order in response to a signal in the third set of signals being transmitted to the second wireless device using a same carrier frequency after the RTP measurement center time, and each signal in the fourth set of signals being associated with a carrier frequency in the set of carrier frequencies;
determine a distance from the first wireless device to the second wireless device based at least in part on an RTP measurement for each carrier frequency in the set of carrier frequencies sampled prior to the RTP measurement center time and after the RTP measurement center time; and
wherein the code to determine the distance from the first wireless device to the second wireless device is configured to:
fit a line between each of the RTP measurements made for each carrier frequency in the set of carrier frequencies sampled prior to the RTP measurement center time and after the RTP measurement center time.

11. (canceled)

12. (canceled)
